(19) United States
(12) Patent Application Publication
(10) Pub. No.: US 2018/0063371 A1
(43) Pub. Date: Mar. 1, 2018

(54) IMAGE PROCESSING DEVICE, IMAGE FORMING APPARATUS, AND NON-TRANSITORY COMPUTER READABLE MEDIUM

(71) Applicant: FUJI XEROX CO., LTD., Tokyo (JP)

(72) Inventors: Hiroshi HAYASHI, Kanagawa (JP); Tetsuya WAKIYAMA, Kanagawa (JP); Masashi OKANO, Kanagawa (JP); Hiroshi NIINA, Kanagawa (JP); Junichi SHIMIZU, Kanagawa (JP); Kiyotaka TSUCHIBUCHI, Kanagawa (JP)

(73) Assignee: FUJI XEROX CO., LTD., Tokyo (JP)

(21) Appl. No.: 15/609,746

(22) Filed: May 31, 2017

(30) Foreign Application Priority Data
Aug. 25, 2016 (JP) 2016-165041

(51) Int. Cl. H04N 1/409; H04N 1/60; H04N 1/00; G06T 3/60; G06T 5/50; G06T 7/90

(52) U.S. Cl. CPC H04N 1/4092; H04N 1/6008; H04N 1/00718; H04N 2201/0094; G06T 5/50; G06T 7/90; G06T 2207/20224; G06T 3/60

(57) ABSTRACT

An image processing device includes an acquisition unit and an image processing unit. The acquisition unit acquires execution information regarding necessary processing units of plural processing units for performing an image process and an order in which the processing units are executed from an external apparatus. The image processing unit performs the image process by executing the necessary processing units in the order indicated by the acquired execution information.

### CROSS-REFERENCE TO RELATED APPLICATIONS

This application is based on and claims priority under 35 USC 119 from Japanese Patent. Application No. 2016-165041 filed Aug. 25, 2016.

### BACKGROUND

### (i) Technical Field

The present invention relates to an image processing device, an image forming apparatus, and a non-transitory computer readable medium.

### (ii) Related Art

In image forming apparatuses such as multifunction machines or printers using an electrophotographic system, an inkjet system, or the like, after various image processes are performed for input image information, an image may be formed by an image forming device. The image processes are, for example, implemented by executing processing units of plural predetermined types in order.

### SUMMARY

According to an aspect of the invention, there is provided an image processing device including an acquisition unit and an image processing unit. The acquisition unit acquires execution information regarding necessary processing units of plural processing units for performing an image process and an order in which the processing units are executed from an external apparatus. The image processing unit performs the image process by executing the necessary processing units in the order indicated by the acquired execution information,

### BRIEF DESCRIPTION OF THE DRAWINGS

Exemplary embodiments of the present invention will be described in detail based on the following figures, wherein:

FIG. 1 is a diagram illustrating an example of a hardware configuration of an image forming apparatus;

FIG. 2 is a diagram illustrating a signal processing system for a normal image process in a controller of an image forming apparatus;

FIG. 3 is a diagram for explaining a signal processing system in a first exemplary embodiment;

FIG. 4 is a diagram for explaining a signal processing system in a second exemplary embodiment;

FIG. 5 is a diagram for explaining a signal processing system in a third exemplary embodiment; and

FIG. 6 is a diagram for explaining a signal processing system in a fourth exemplary embodiment.

### DETAILED DESCRIPTION

### <Explanation for Entire Configuration of Image Forming Apparatus>

Hereinafter, exemplary embodiments of the present invention will be described in detail with reference to the drawings.

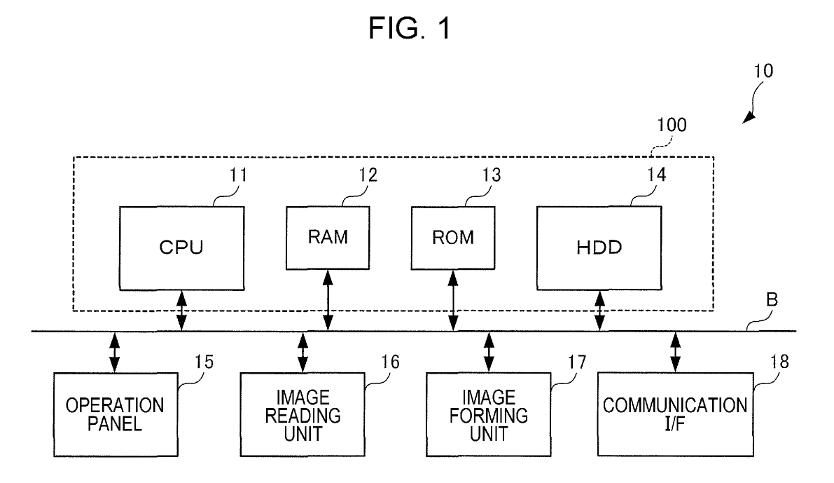

FIG. 1 is a diagram illustrating an example of a hardware configuration of an image forming apparatus 10.

As illustrated in FIG. 1, the image forming apparatus 10 includes a central processing unit (CPU) 11, a random access memory (RAM) 12, a read only memory (ROM) 13, a hard disk drive (HDD) 14, an operation panel 15, an image reading unit 16, an image forming unit 17, and a communication interface (I/F) 18. The CPU 11, the RAM 12, the ROM 13, the HDD 14, the operation panel 15, the image reading unit 16, the image forming unit 17, and the communication I/F 18 exchange necessary data via a bus B.

The CPU 11 implements functions described below by loading various programs stored in the ROM 13 or the like into the RAM 12 and executing the programs.

The RAM 12 is a memory used as an operation memory or the like for the CPU 11.

The ROM 13 is a memory which stores various programs and the like to be executed by the CPU 11.

The HDD 14 is, for example, a magnetic disk device which stores image information read by the image reading unit 16, image information to be used for image formation in the image forming unit 17, and the like.

The operation panel 15 is, for example, a touch panel which displays various types of information and receives an operation input by a user.

The image reading unit 16 reads an image recorded in an original. The image reading unit 16 is, for example, a scanner. The scanner may be of, for example, a charge coupled devices (CCD) system which reduces light reflected to light applied from a light source to an original through a lens and receives the reflection light at the CCD or a contact image sensor (CIS) system which receives light reflected to light sequentially applied from an LED light source to an original through the CIS.

The image forming unit 17 is an example of a printing mechanism which forms an image on a recording medium. The image forming unit 17 is, for example, a printer. The printer may be of, for example, an electrophotographic system which transfers toner deposited on a photoreceptor to a recording medium such as paper to form an image or an inkjet system which ejects ink to a recording medium to form an image.

The communication I/F 18 transmits and receives various types of information to and from an external apparatus via a network.

Furthermore, in an exemplary embodiment, a controller 50 which controls each mechanism unit of the image forming apparatus 10 is configured by the CPU 11, the RAM 12, the ROM 13, and the HDD 14. As described in detail later, the controller 50 functions as an example of an image processing device (image processing unit) which performs an image process for image information to be used to form an image at the image forming unit 17.

### <Explanation for Signal Processing System>

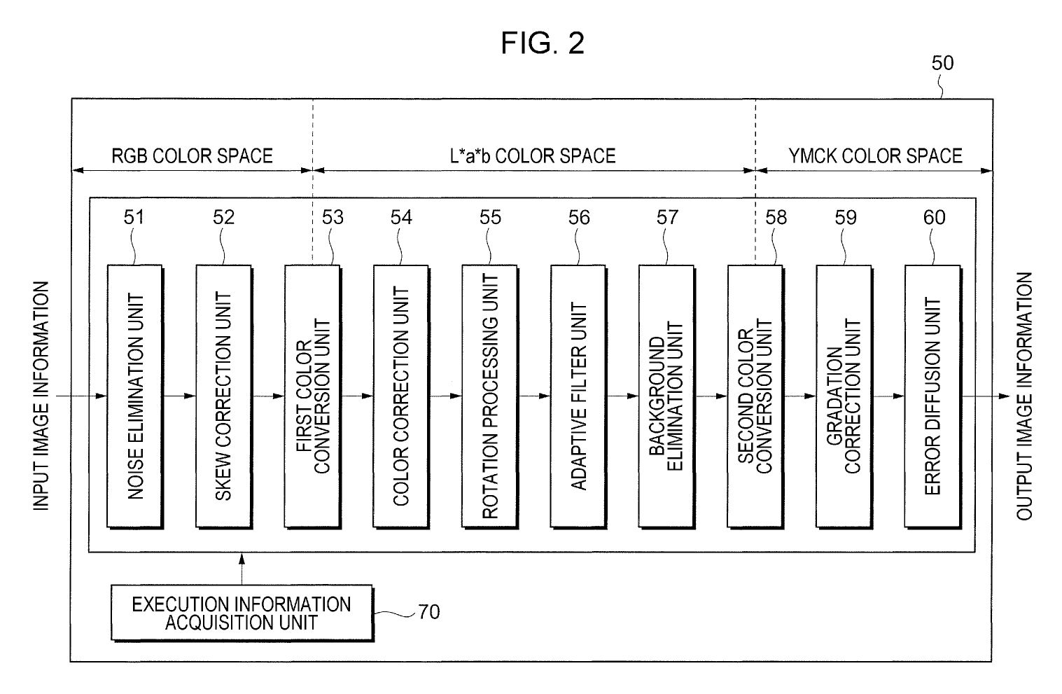

FIG. 2 is a diagram illustrating a signal processing system for a normal image process in the controller 50 of the image forming apparatus 10.

In FIG. 2, an example in which the image forming apparatus 10 is configured as a printer is illustrated. The flow of a process for an image signal in the case of a normal image process will be described below with reference to FIG. 2.

The controller 50 includes a noise elimination unit 51, a skew correction unit 52, a first color conversion unit 53, a color correction unit 54, a rotation processing unit 55, an adaptive filter unit 56, a background elimination unit 57, a second color conversion unit 58, a gradation correction unit 59, an error diffusion unit 60, and an execution information acquisition unit 70.

The noise elimination unit 51 eliminates noise from input image information (input image information). This noise is, for example, caused by dirt attached to the image reading unit 16. In this case, when the image reading unit 16 reads an image of an original, streaky noise in a sub-scanning direction is caused by the dirt. Therefore, the noise elimination unit 51 detects and eliminates the noise.

In this case, the input image information is RGB data of red (R), green. (G), and blue (B), which is color data in an RGB color space.

The skew correction unit 52 corrects the inclination (skew) of an original. For example, the skew correction unit 52 detects an end portion of the original. Based on the detected end portion, the skew correction unit 52 detects a skew angle, and performs skew correction.

The first color conversion unit 53 converts RGB data in an. RGB color space into L*a*b data in an L*a*b color space. The first color conversion unit 53 performs color conversion using a direct look up table (DLUT), which is a multi-dimensional color conversion table, or a one-dimensional look up table (LUT).

The color correction unit 54 performs color correction of L*a*b data.

In the image forming unit 17, color tone varies (color variations occur) by variations with time of each unit. Therefore, the color correction unit 54 performs color correction using a DLUT or a one-dimensional LUT to adjust the color variations.

The rotation processing unit 55 performs processing for rotating an image based on image information.

In the case where the long-side direction and the short-side direction of a read original differ from those of a recording medium such as paper, the rotation processing unit 55 rotates an image to cause the orientation of the original and the orientation of the recording medium to be aligned. For example, a case where the image forming apparatus 10 performs copying such that the image reading unit 16 first reads an image of an original and then the image forming unit 17 forms the image, will be considered. In this case, when a user causes the original to be read from the short-side direction (Short Edge Feed), if the short-side direction of the original and the long-side direction of the recording medium are the same, the rotation processing unit 55 rotates the image by 90 degrees. Accordingly, as in the case where the original is read from the long-side direction (Long Edge Feed), the long-side and short-side directions of the original are aligned with the long-side and short-side directions of the recording medium.

For example, the adaptive filter unit 56 performs processing for emphasizing an edge for a character region of an image, and performs smoothing processing for an image region.

The background elimination unit 57 performs processing for detecting and eliminating the background color from an image. That is, the background elimination unit 57 performs processing for detecting a portion not including a character or image from an original, detecting the background color, which is the color of the portion, and eliminating the background color.

The second color conversion unit 58 converts L*a*b data in an L*a*b color space into YMCK data, which represents reproduction colors (colors of toner as color materials: yellow Y, magenta M, cyan C, and black K), and outputs the YMCK data. The YMCK data includes separated data of individual colors: Y data, M data, C data, and K data. The second color conversion unit 58 performs color conversion using a DLUT, which is a multi-dimensional color conversion table.

The gradation correction unit 59 performs gradation correction for each of the colors: yellow Y, magenta M, cyan C, and black K, using gradation correction information. The gradation correction information is, for example, in the form of an LUT, which is a one-dimensional table.

The error diffusion unit 60 performs screen processing for image information by error diffusion processing using a predetermined error diffusion pattern. Accordingly, the image information is changed from multi-value image information (multi-value image data) represented by multiple values into binary image information (binary image data) represented by two values.

Binary image information is output from the error diffusion unit 60 for each of the colors: yellow Y, magenta M, cyan C, and black K, as output image information.

In an exemplary embodiment, each of the noise elimination unit 51, the skew correction unit 52, the first color conversion unit 53, the color correction unit 54, the rotation processing unit 55, the adaptive filter unit 56, the background elimination unit 57, the second color conversion unit 58, the gradation correction unit 59, and the error diffusion unit 60 may be considered to be processing unit for performing an image process. The above processing unit is an independent program for performing the above-described corresponding processing. By executing the plural processing units in a predetermined order, a predetermined image process may be achieved as a whole. Furthermore, by collectively executing the processing units, the noise elimination unit 51, the skew correction unit 52, the first color conversion unit 53, the color correction unit 54, the rotation processing unit 55, the adaptive filter unit 56, the background elimination unit 57, the second color conversion unit 58, the gradation correction unit 59, and the error diffusion unit 60 function as an image processing unit which performs an image process.

However, depending on the type of an image to be processed, the above processing order may not be preferable. Furthermore, depending on the need of a user, the above processing order may not be preferable.

In an exemplary embodiment, the order of the processing units: the noise elimination unit 51, the skew correction unit 52, the first color conversion unit 53, the color correction unit 54, the rotation processing unit 55, the adaptive filter unit 56, the background elimination unit 57, the second color conversion unit 58, the gradation correction unit 59, and the error diffusion unit 60, is changed or a part of the processing units is not executed, in accordance with the details of the image process. Accordingly, an image process which matches the type of an image to be processed and the need of a user may be achieved.

In the case where known hardware including a dedicated circuit for an image process such as an application specific integrated circuit (ASIC) is adopted, operation of the noise elimination unit 51, the skew correction unit 52, the first color conversion unit 53, the color correction unit 54, the rotation processing unit 55, the adaptive filter unit 56, the background elimination unit 57, the second color conversion unit 58, the gradation correction unit 59, and the error diffusion unit 60 is fixed. That is, changing the order of the processing units or non-execution of a part of the processing units is not possible. In contrast, in an exemplary embodiment, processing is implemented by software in the CPU 11 instead of an ASIC. Therefore, changing the order of the processing units or non-execution of a part of the processing units may be achieved.

The execution information acquisition unit 70 is an example of an acquisition unit, and acquires execution information regarding necessary processing units of the processing units represented by the noise elimination unit 51, the skew correction unit 52, the first color conversion unit 53, the color correction unit 54, the rotation processing unit 55, the adaptive filter unit 56, the background elimination unit 57, the second color conversion unit 58, the gradation correction unit 59, and the error diffusion unit 60 and the execution order of the processing units from an external apparatus.

Then, an image process is performed by executing the necessary processing units in the order indicated by the acquired execution information.

In this case, an external apparatus is an apparatus which is external relative to the image forming apparatus 10. However, the external apparatus is not particularly limited. For example, the external apparatus may be a personal computer (PC) or a server which is connected via the Internet or a local area network (LAN) or a PC, a universal serial bus (USB) memory, or the like which is directly connected to the image forming apparatus 10.

The execution information is, for example, application software. According to the purpose such as “image quality priority”, “productivity priority”, or the like, the details of a corresponding image process are described in the execution information. In this case, the details of an image process are about necessary processing units and the execution order of the processing units. The application software is, for example, prepared by a manufacturer of the image forming apparatus 10, and a user downloads the application software from the external apparatus to the image forming apparatus 10. In an exemplary embodiment, the execution information acquisition unit 70 acquires the application software. For example, when a user selects “image quality priority”, “productivity priority”, or the like from a menu indicated on the operation panel 15, the corresponding application software is executed. Accordingly, the controller 50 executes the necessary processing units in the order indicated by the acquired execution information, and the image process is thus performed.

Hereinafter, a signal processing system when the execution information acquisition unit 70 acquires execution information will be described.

### First Exemplary Embodiment

First, a first exemplary embodiment will be described.

In the first exemplary embodiment, a case where the order of processing units is changed will be explained.

In this case, execution information includes the details indicating that the execution order of plural processing units is changed to a predetermined order in accordance with the details of an image process. The plural processing units are executed in accordance with the predetermined order.

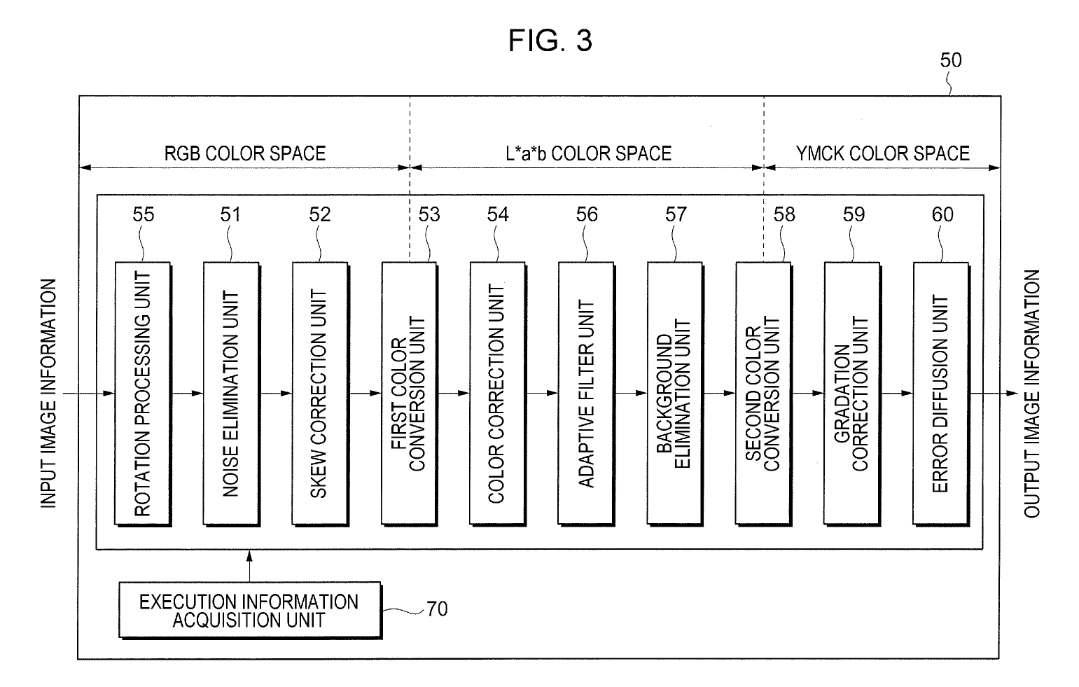

FIG. 3 is a diagram for explaining a signal processing system in the first exemplary embodiment.

In the example illustrated in. FIG. 2, the rotation processing unit 55 is positioned after the color correction unit 54. Thus, after color correction is performed, rotation processing for rotating an image is performed. However, in the example illustrated in FIG. 3, the rotation processing unit 55 is positioned at the front, and after that, the noise elimination unit 51 is positioned. Accordingly, rotation processing is performed first, and the other processing is performed after the rotation processing.

By performing rotation processing from the Short Edge Feed to the Long Edge Feed, the amount of image information for each line increases. Therefore, the amount of image information for each transfer unit increases, for example, when burst transfer of image information to an operation memory such as the RAM 12 is performed, and the transfer efficiency is thus increased. As a result, a faster image process is achieved, and the time required for an image process may be shortened.

### Second Exemplary Embodiment

Next, a second exemplary embodiment will be described.

In the second exemplary embodiment, a case where a part of processing units is not executed will be explained. In this case, execution information includes the details indicating that a part of plural processing units to be executed in a predetermined order is not executed in accordance with the details of an image process. In accordance with this, execution of a part of the processing units is omitted.

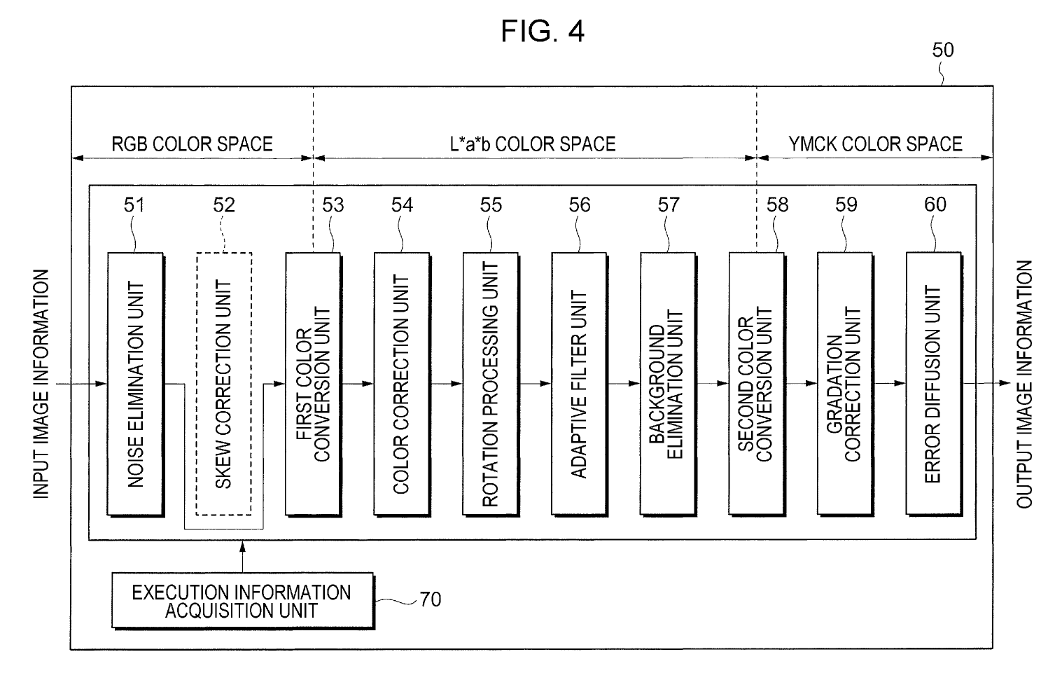

FIG. 4 is a diagram for explaining a signal processing system in the second exemplary embodiment.

In the example illustrated in FIG. 2, the skew correction unit 52 corrects the inclination (skew) of an original. However, in the example illustrated in FIG. 4, correction of the inclination of an original is not performed, that is, this processing is skipped. Therefore, after the noise elimination unit 51 eliminates noise from input image information, the first color conversion unit 53 performs processing for color conversion.

By not performing skew correction as described above, a faster image process is achieved, and the time required for an image process may be shortened. Therefore, this configuration is particularly effective for the case where priority is given to the productivity.

### Third Exemplary Embodiment

Next, a third exemplary embodiment will be described.

In the third exemplary embodiment, a case where the order of processing units is changed will be explained.

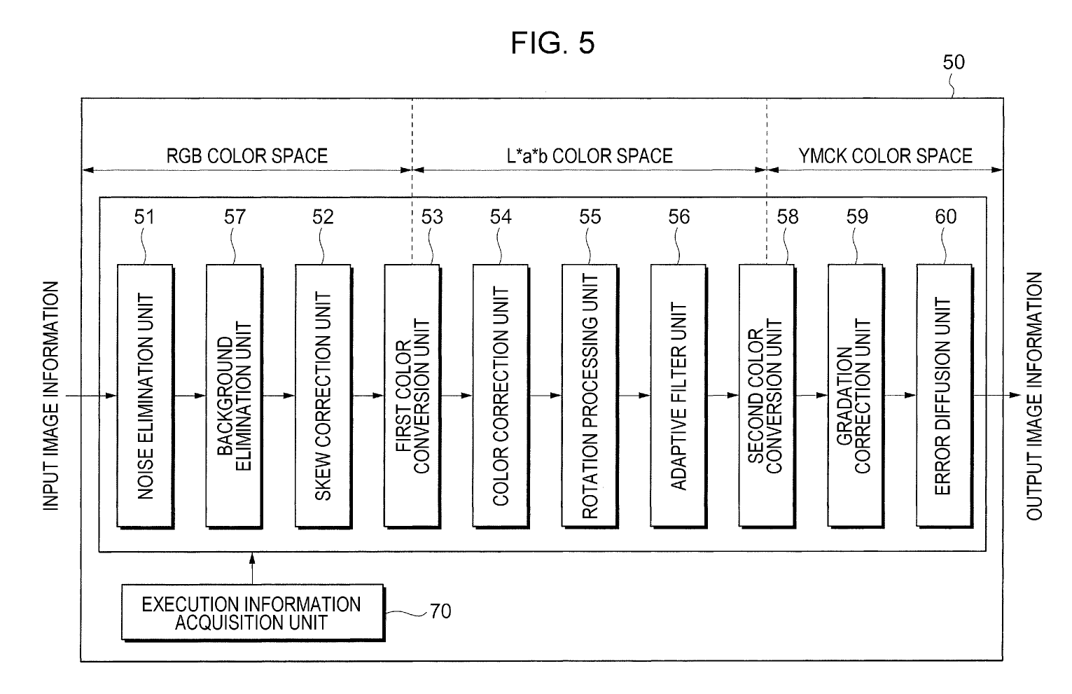

FIG. 5 is a diagram for explaining a signal processing system in the third exemplary embodiment.

In the example illustrated in FIG. 2, the background elimination unit 57 is positioned after the adaptive filter unit 56, and after adaptive filter processing is performed, background detection and elimination processing for detecting and eliminating the background color is performed. However, in the example illustrated in FIG. 5, the background elimination unit 57 is positioned subsequent to the noise elimination unit 51. Accordingly, after noise in an image is eliminated, background detection and elimination is performed.

Therefore, background detection and elimination is performed in an RGB color space, instead of in an L*a*b color space. As a result, the amount of operation for a processing unit after the background elimination unit 57 is reduced, and the time required for an image process may be shortened. Therefore, this configuration is particularly effective for the case where priority is given to the productivity.

### Fourth Exemplary Embodiment

Next, a fourth exemplary embodiment will be described.

In the fourth exemplary embodiment, a case where a part of processing units is not executed will be described.

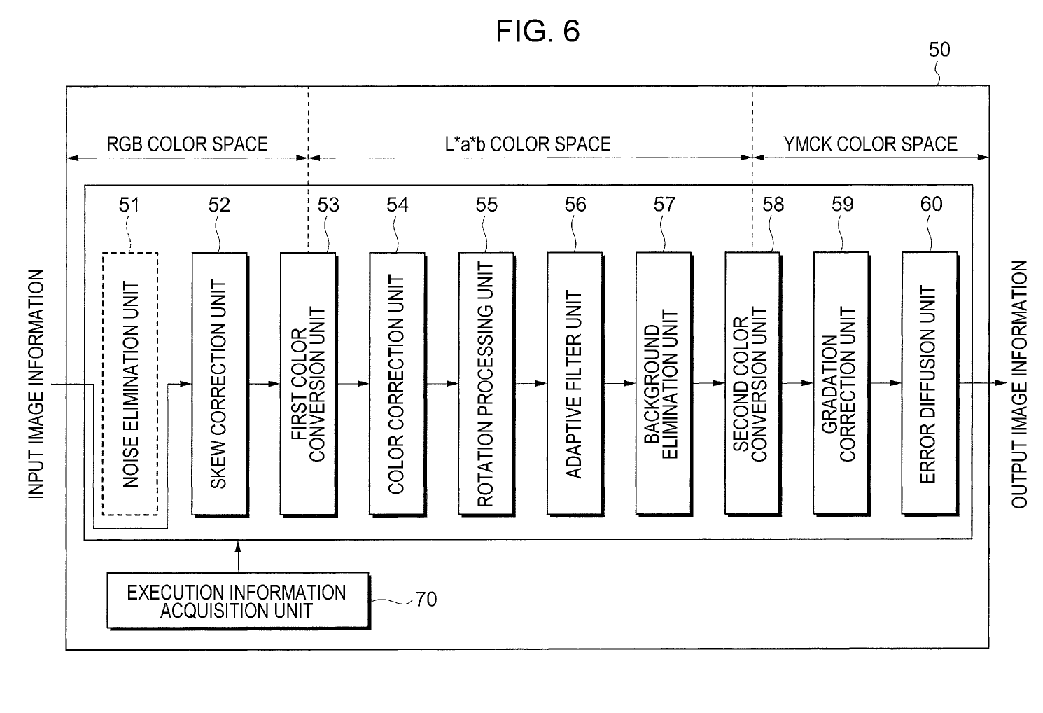

FIG. 6 is a diagram for explaining a signal processing system in the fourth exemplary embodiment.

In the example illustrated in FIG. 2, the noise elimination unit 51 eliminates noise in an image. However, in the example illustrated in FIG. 6, elimination of noise is not performed, that is, this processing is skipped. Therefore, a series of processes starts from the processing unit corresponding to the skew correction unit 52.

By not performing elimination of noise as described above, a faster image process is achieved, and the time required for an image process may be shortened. Therefore, this configuration is particularly effective for the case where priority is given to the productivity.

According to the foregoing exemplary embodiments, for execution of an image process, change may be performed for plural types of processing, so that an image process which corresponds to an image to be processed and fits a purpose may be achieved.

In the examples described above, cases where an image process for image formation is performed have been described. However, the present invention is not limited to the above examples. The present invention may also be applied to an image processing device which implements an image process by executing plural processing units in order.

### <Explanation for Program>

A process performed by the controller 50 is implemented by cooperation of software and hardware resources.

Therefore, processing that the controller 50 performs may be regarded as a program which causes a computer to implement an acquisition function for acquiring execution information regarding necessary processing units of plural processing units for performing an image process and the order in which the processing units are executed from an external apparatus and n image processing function for performing an image process by executing the necessary processing units in the order indicated by the acquired execution information.

The foregoing description of the exemplary embodiments the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
an acquisition unit that acquires execution information regarding necessary processing units of a plurality of processing units for performing an image process and an order in which the processing units are executed from an external apparatus; and
an image processing unit that performs the image process by executing the necessary processing units in the order indicated by the acquired execution information.

2. The image processing device according to claim 1,
wherein the execution information includes details indicating that the order in which the plurality of processing units are executed is changed to a predetermined order in accordance with details of the image process.

3. The image processing device according to claim 2,
wherein the processing units include at least one of rotation processing for rotating an image and background detection and elimination for detecting a color of a background from the image and eliminating the color of the background.

4. The image processing device according to claim 1,
wherein the execution information includes details indicating that a part of the plurality of processing units that are executed in a predetermined order is not executed in accordance with details of the image process.

5. The image processing device according to claim 2,
wherein the execution information includes details indicating that a part of the plurality of processing units that are executed in a predetermined order is not executed in accordance with details of the image process.

6. The image processing device according to claim 3,
wherein the execution information includes details indicating that a part of the plurality of processing units that are executed in a predetermined order is not executed in accordance with details of the image process.

7. The image processing device according to claim 4,
wherein the processing units include at least one of skew correction for correcting inclination of an image and noise detection and elimination for detecting and eliminating noise in the image.

8. The image processing device according to claim 5,
wherein the processing units include at least one of skew correction for correcting inclination of an image and noise detection and elimination for detecting and eliminating noise in the image.

9. The image processing device according to claim 6,
wherein the processing units include at least one of skew correction for correcting inclination of an image and noise detection and elimination for detecting and eliminating noise in the image.

10. An image forming apparatus comprising:
an image forming unit that forms an image on a recording medium; and
an image processing unit that performs an image process for image information to be used for forming the image at the image forming unit,
wherein the image processing unit includes
an acquisition part that acquires execution information regarding necessary processing units of a plurality of processing units for performing an image process and an order in which the processing units are executed from an external apparatus, and
an image processing part that performs the image process key executing the necessary processing units in the order indicated by the acquired execution information.

11. A non-transitory computer readable medium storing a program causing a computer to execute a process for image processing, the process comprising:
acquiring execution information regarding necessary processing units of a plurality of processing units for performing an image process and an order in which the processing units are executed from an external apparatus; and
performing the image process by executing the necessary processing units in the order indicated by the acquired execution information.
